(19) United States
(12) Patent Application Publication
(10) Pub. No.: US 2026/0174075 A1
(43) Pub. Date: Jun. 25, 2026

(54) ELECTRICAL TRAPPING SYSTEM

(71) Applicant: Cheryl Meads, Hobe Sound, FL (US)

(72) Inventor: Cheryl Meads, Hobe Sound, FL (US)

(21) Appl. No.: 19/416,501

(22) Filed: Dec. 11, 2025

Related U.S. Application Data
(60) Provisional application No. 63/738,058, filed on Dec. 23, 2024.

(51) Int. Cl. A01M 23/38; A01M 23/18

(52) U.S. Cl. CPC A01M 23/38; A01M 23/18

(57) ABSTRACT

An electrical trapping system, comprising an electrically conducting platform isolated from ground via one or more supports. The electrical trapping system further comprises a power supply coupled to the electrically conducting platform. The electrical trapping system further comprises an electric trap controller coupled to the power supply. The electric trap controller is configured to cause the power supply to discharge an electrical charge to the electrically conducting platform to incapacitate an animal electrically coupled with the electrically conducting platform.

### BENEFIT CLAIM

This application claims the benefit of U.S. Provisional Ser. No. 63/738,058 entitled “ELECTRICAL TRAPPING SYSTEM” filed on Dec. 23, 2024, which is expressly incorporated herein by reference.

### FIELD OF THE INVENTION

This invention relates generally to the field of electrical trapping devices, and more particularly, embodiments of the invention relate to an electrical trapping system configured to trap nuisance animals, including reptiles.

### BACKGROUND OF THE INVENTION

Wild animals can be nuisances to humans due to the diseases they carry and the destruction they can cause. Most mammals, when they become a nuisance, can be tranquilized and/or trapped to remedy the problem. However, reptiles can be difficult to trap due to their physical characteristics including scales, cold-bloodedness, ability to procreate rapidly and dense populations. Further, many nuisance reptiles in the United States were once exotic pets not native to the United States that were released into the wild with no natural predators capable of maintaining their populations. With habitats that allow these reptiles to thrive and no natural predators, the reptiles'population can explode into significant numbers. For example, iguana populations in Florida have increased significantly in the decades since they were first spotted in the wild. This presents a unique problem in trapping nuisance reptiles. Most animal traps are designed to trap a single animal, but due to the dense populations of reptiles, a large number can converge simultaneously on a single trap rendering it ineffective. Additionally, in conventional animal traps, when the trap is triggered, no additional animals can be trapped until the animal is removed. A need exists to trap multiple reptiles at a time, while being able to rapidly redeploy the trap to continue trapping as many reptiles as possible in a short period of time.

### BRIEF SUMMARY

Shortcomings of the prior art are overcome and additional advantages are provided through the provision of an electrical trapping system. The system includes, for instance, an electrically conducting platform isolated from ground via one or more supports; a power supply coupled to the electrically conducting platform; and an electric trap controller coupled to the power supply. The electric trap controller is configured to cause the power supply to discharge an electrical charge to the electrically conducting platform to incapacitate an animal electrically coupled with the electrically conducting platform.

In an embodiment, the electrical trapping system further comprises an activation device configured to cause the electric trap controller to cause the power supply to discharge an electrical charge to the electrically conducting platform.

In an embodiment, the electrical trapping system further comprises a sensor coupled with the electric trap controller. The sensor is configured to provide one or more signals to the electric trap controller regarding a status of at least one characteristic of the power supply, the electrically conducting platform, or the electric trap controller.

In an embodiment, the electrical trapping system further comprises a camera configured to capture one or more images or videos. The camera is configured to provide the one or more images or videos to the electric trap controller. The electric trap controller is configured to perform image processing on the images or videos. The electric trap controller is configured to take one or more actions based on the image processing.

In an embodiment, the electrical trapping system further comprises a speaker configured to produce one or more audible noises or messages based on a communication received from the electric trap controller.

In an embodiment, the electrical trapping system further comprises a warning device configured to provide a warning in the area surrounding the electrical trapping system. The warning device can provide the warning based on a command from the electric trap controller.

In an embodiment, the electrical trapping system further comprises a computing device in communication with the electric trap controller.

In an embodiment, the electrical trapping system further comprises a bait container located on a surface of the electrically conductive platform. The bait container is configured to store bait intended to attract one or more animals.

In an embodiment, the electrically conducting platform and the one or more supports are configured to have the animal partially located on the electrically conducting platform and the ground. The animal functions as a closed circuit between the electrically conducting platform and the ground thereby shocking the animal once electricity is provided to the electrically conducting platform.

In an embodiment, the electrically conducing platform comprises a metal. The electrically conducting platform can comprise a primarily circular shape

In an embodiment, the electrical trapping system further comprises a safety enclosure completely surrounding the electrically conducting platform. The safety enclosure comprises a door that is configured to be opened to create an opening in the safety enclosure. The door is further configured to be closed sealing the opening in the safety enclosure.

In an embodiment, the electric trap controller controls operation of the door.

In an embodiment, an electrical trapping system comprises a plurality of electrical trap units. Each of the plurality of electrical trap units respectively comprises: an electrically conducting platform isolated from ground via one or more supports, a power supply coupled to the electrically conducting platform, and an electric trap controller coupled to the power supply. The electric trap controller is configured to cause the power supply to discharge an electrical charge to the electrically conducting platform to incapacitate an animal electrically coupled with the electrically conducting platform. The respective electric trap controllers of the plurality of electrical trap units are configured to communicate with at least one additional electrical trap unit of the plurality of electrical trap units.

In an embodiment, each of the plurality of electrical trap units further comprises an activation device configured to cause the respective electric trap controller to cause the respective power supply to discharge the electrical charge to the electrically conducting platform, and a respective bait container located on a surface of the electrically conductive platform. The respective bait container is configured to store bait intended to attract one or more animals.

In an embodiment, each of the plurality of electrical trap units further comprises a respective sensor coupled with the respective electric trap controller. The respective sensor is configured to provide one or more signals to the respective electric trap controller regarding a status of at least one characteristic of the respective power supply, the respective electrically conducting platform, and the respective electric trap controller.

In an embodiment, each of the plurality of electrical trap units further comprises a respective camera configured to capture one or more images or videos. The respective camera is configured to provide the one or more images or videos to the respective electric trap controller. The respective electric trap controller is configured to perform image processing on the images or videos, and the respective electric trap controller is configured to take one or more actions based on the image processing.

In an embodiment, each of the plurality of electrical trap units further comprises a respective speaker configured to produce one or more audible noises or messages based on a communication received from the respective electric trap controller. Each of the plurality of electrical trap units further comprises a respective safety enclosure completely surrounding the respective electrically conducting platform. The respective safety enclosure comprises a respective door that is configured to be opened to create a respective opening in the respective safety enclosure. The respective door is further configured to be closed sealing the respective opening in the respective safety enclosure. The respective electric trap controller controls operation of the respective door.

In an embodiment, the respective electrically conducting platform and the respective one or more supports are configured to have the animal partially located on the respective electrically conducting platform and ground. The animal functions as a respective closed switch between the respective electrically conducting platform and the ground thereby shocking the respective animal once electricity is provided to the respective electrically conducting platform.

In an embodiment, an electrical trapping system comprises a plurality of electrical trap units. Each of the plurality of electrical trap units respectively comprises an electrically conducting platform isolated from ground via one or more supports, a power supply coupled to the electrically conducting platform, and an electric trap controller coupled to the power supply. The electric trap controller is configured to cause the power supply to discharge an electrical charge to the electrically conducting platform to incapacitate an animal electrically coupled with the electrically conducting platform. The electrical trapping system further comprises an electric trap controller in communication with each of the plurality of electrical trap units. The electric trap controller is configured to cause each of the respective power supplies of the plurality of electrical trap units to discharge an electrical charge to each of the respective electrically conducting platforms of the plurality of electrical trap units to incapacitate one or more animals electrically coupled with at least one of the electrically conducting platforms.

In an embodiment, each of the plurality of electrical trap units further comprises an activation device configured to cause the respective power supply to discharge the electrical charge to the electrically conducting platform, and a respective bait container located on a surface of the electrically conductive platform. The respective bait container is configured to store bait intended to attract one or more animals.

In an embodiment, each of the plurality of electrical trap units further comprises a respective sensor coupled with the electric trap controller. The respective sensor is configured to provide one or more signals to the electric trap controller regarding a status of at least one characteristic of the respective power supply, and the respective electrically conducting platform.

In an embodiment, each of the plurality of electrical trap units further comprises a respective camera configured to capture one or more images or videos. The respective camera is configured to provide the one or more images or videos to the electric trap controller. The electric trap controller is configured to perform image processing on the images or videos. The electric trap controller is configured to take one or more actions based on the image processing.

In an embodiment, each of the plurality of electrical trap units further comprises a respective speaker configured to produce one or more audible noises or messages based on a communication received from the electric trap controller, and further comprising a respective safety enclosure completely surrounding the respective electrically conducting platform. The respective safety enclosure comprises a respective door that is configured to be opened to create a respective opening in the respective safety enclosure. The respective door is further configured to be closed sealing the respective opening in the respective safety enclosure. The electric trap controller controls operation of the respective door.

In an embodiment, the respective electrically conducting platform and the respective one or more supports are configured to have the animal partially located on the respective electrically conducting platform and ground. The animal functions as a respective closed switch between the respective electrically conducting platform and the ground thereby shocking the respective animal once electricity is provided to the respective electrically conducting platform.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an electrical trap system, according to at least one embodiment;

FIG. 2 illustrates a diagram of an electric system, according to at least one embodiment;

FIG. 3 illustrates an electrical diagram of an electric trap circuit, according to at least one embodiment;

FIG. 4 illustrates an electrical diagram of an electric trap circuit, according to at least one embodiment;

FIGS. 5A-5C illustrate an electrical trap system with a safety enclosure, according to at least one embodiment;

FIG. 6 illustrates an electrical trap system, according to at least one embodiment; and

FIG. 7 illustrates an electrical trap system, according to at least one embodiment.

### DETAILED DESCRIPTION

Aspects of the present invention and certain features, advantages, and details thereof are explained more fully below with reference to the non-limiting examples illustrated in the accompanying drawings. Descriptions of well-known processing techniques, systems, components, etc. are omitted so as to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Like numbers refer to like elements throughout. Unless defined otherwise, technical and scientific terms used herein have the same meaning as commonly understood to one of ordinary skill in the art to which the presently disclosed subject matter pertains.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Furthermore, a device or structure that is configured in a certain way is configured in at least that way, but may also be configured in ways that are not listed.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method, step of a method, device or element of a device that “comprises,” “has,” “includes,” or “contains,” or uses similar language to describe one or more steps or elements possesses those one or more steps or elements, but is not limited to possessing only those one or more steps or elements.

The terms “couple,” “coupled,” “connected,” and the like should be broadly understood to refer to connecting two or more elements or signals electrically and/or mechanically, either directly or indirectly, wired or wirelessly, through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

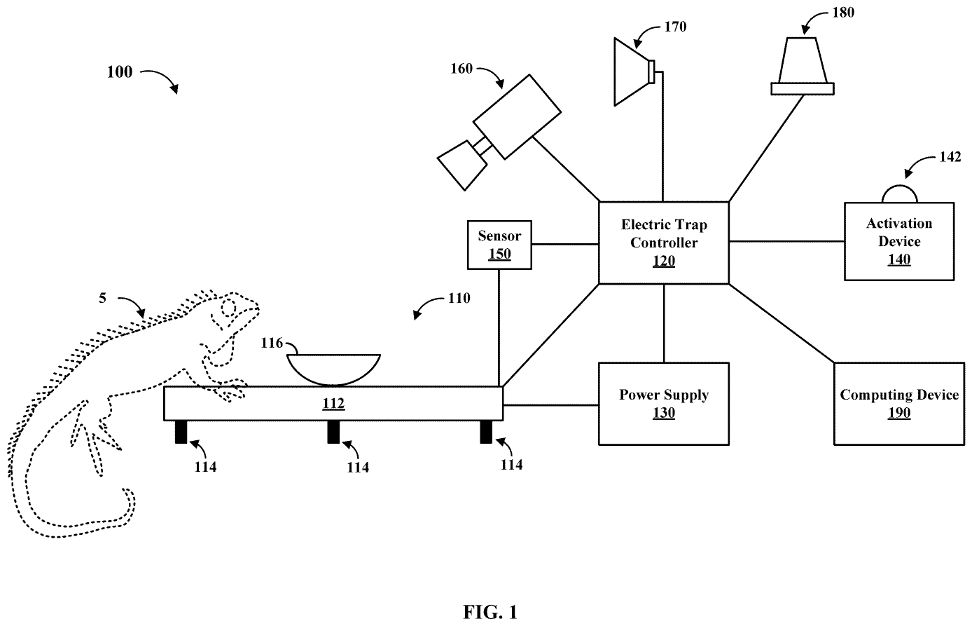

FIG. 1 illustrates an electrical trap system 100, according to at least one embodiment. The electrical trap system 100 comprises an electric trap 110, an electric trap controller 120, a power supply 130, an activation device 140, a sensor 150, a camera 160, a speaker 170, a warning device 180, and a computing device 190. The electric trap system 100 is configured to lure a reptile 5 onto the electric trap 110. The electric trap 110 is placed on the ground and is configured to allow the reptile 5 to be partially located on a platform 112, while also being partially located on the ground (not shown). The reptile 5 can create an electrical connection between the platform 112 and the ground such that when an electrical current is applied to the platform 112, the electrical current travels to the ground via the reptile 5. That is, the reptile 5 acts as a conduit for the electricity applied to the platform 112, which causes the reptile 5 to be electrocuted. The electrical current provided to the platform 112 is configured to render the reptile 5 incapacitated. Thus, the electrical trap system 100 is configured to provide an electric shock to the reptile 5 rendering the reptile 5 incapacitated. The electric trap system 100 can be configured to be weatherproof such that the electric trap system 100 is capable of operating in a variety of environments and weather conditions. As will be appreciated by one skilled in the art, the number of reptiles 5, as well as the size of the reptiles 5, will dictate not only the size of the platform 112, but also the amount of electrical energy required to be provided to the platform 112 to render the reptiles 5 incapacitated. Thus, the electrical trap system 100 can be configured to handle a variety of reptiles 5 and environments.

The electric trap 110 comprises a platform 112, supports 114, and a bait container 116. The platform 112 is electrically coupled with the power supply 130 such that the power supply 130 can provide electrical power to the platform 112. The platform 112 comprises an electrical conducting platform that is configured to conduct electrical energy across and through the platform 112 (e.g., from the power supply 130). That is, the platform 112 can be electrically charged to incapacitate the reptile 5. The platform 112 can comprise any electrically conducting material, such as metal (e.g., aluminum, copper, steel, etc.), a semi-conductor, conducting non-metals (e.g., graphite), etc. The platform 112 can comprise any shape and size. In an embodiment, the platform 112 is configured to allow the reptile 5 to be partially located on the platform 112, as well as partially located on the ground, while the reptile 5 is attempting to consume the bait located within the bait container 116. The size and/or shape of the platform 112 can be determined based on the reptile 5 desiring to be trapped. Accordingly, the shape and size of the platform 112 can be configured based on the size and/or type of reptile 5.

In an embodiment, the platform 112 comprises a generally circular shape. The bait container 116 is placed at the center of the circular shape (e.g., the center of the platform 112). By placing the bait container 116 at the center of the platform 112, the bait container 116 can maximize the surface area of the platform 112 capable of providing an electrical shock to one or more reptiles 5. For example, a plurality of reptiles can be lured to the bait container 116, and the reptiles 5 will spread out along the platform 112 to reach the bait within the bait container 116.

The radius of the platform 112 can be configured based on the reptile 5 to be lured and incapacitated. The platform 112 can be configured to support a plurality of reptiles 5. For example, the bait container 116 can lure multiple reptiles 5 to the platform 112, and the platform 112 can be of such a size and/or shape to accommodate the multiple reptiles 5 so that the multiple reptiles 5 can be incapacitated by the electrical trap system 100. For example, if the reptile 5 has an average distance between the front feet of the reptile 5 and the back feet of the reptile 5 between 12 inches to 24 inches, the platform 112 can be designed to have a distance of 12 inches between the container 116 and an edge of the platform 112 to ensure that the majority of the reptiles 5 that are lured onto the platform 112 are partially on the platform 112 and partially on the ground. The dimensions of the platform 112 can be configured based on the specific type of reptile 5 being trapped, as well as how many reptiles 5 that are desired to be trapped at a single time.

The platform 112 is coupled to supports 114. The supports 114 create a base for the platform 112. The supports 114 rest upon an electrical ground (e.g., the ground). The supports 114 comprise an electrically insulating material to create an electrical barrier between the platform 112 and the ground. That is, the supports 114 provide significant electrical resistance between the platform 112 and the ground to prevent any electrical current from passing through from the platform 112 to the ground via the supports 114. The supports 114 can comprise any shape or size. For example, a single large support 114 can be utilized to support the platform 112. The height of the supports 114 can determined based on the reptile 5 that is desiring to be trapped. For example, if the reptile 5 is an iguana, the supports can only be up to a certain height to allow the iguana to crawl up onto the platform 112. If the supports 114 are too high, the reptile 5 would not be able to climb onto the platform to reach the bait container 116. The supports 114 can be configured to allow the reptile 5 to be partially on the platform 112 and partially on the ground. The supports 114 can comprise any electrically insulating materials, such as rubber, glass, ceramic, plastic, etc. The supports 114 can also comprise a combination of electrically insulating and electrically non-insulating materials. For example, the majority of the supports 114 can comprise a metal that has an electrically insulating material on both ends of the supports 114 such that the supports 114 are still electrically insulating even though the supports 114 are not completely made out of an electrically insulating material. The dimensions and materials of the supports 114 can be determined based on not only the reptile 5, but also the electrical trap system 100 configuration. For example, the supports 114 may need to be a stronger or more durable material to support the weight of a larger reptile versus a smaller reptile. Similarly, the material of the supports 114 can be determined based on the amount of electrical energy that is applied to the platform 112 to incapacitate the reptile 5. For example, if a larger amount of electrical energy needs to be applied to the platform 112, the dimension and material of the supports 114 can be larger and more insulating, respectively, to ensure the platform 112 is sufficiently insulated from the ground. While three supports 114 are shown in FIG. 1 for ease of explanation, a person of ordinary skill in the art would appreciate that any number of supports 114 can be utilized to support the platform 112.

The bait container 116 can comprise any container capable of holding and/or storing a bait designed to attract the reptile 5. The bait container 116 is configured to attract the reptile 5 towards the platform 112, as well as onto the platform 112. The bait container 116 can be placed at any location on the platform 112, or even off the platform 112. The bait container 116 can be any size and/or shape. In an embodiment, the bait container 116 comprises a circular shape. The dimensions of the bait container 116 can be configured based on the reptile 5. For example, if the reptile 5 is an iguana, the bait container 116 should be of a size that is large enough to hold enough bait to attract at least one iguana, while not being so large that the iguana is unable to consume the bait located within the bait container 116. The bait container 116 can comprise an electrically conducting material or a non-electrically conducting material. The bait container 116 can be electrically isolated from the platform 112. For example, the bait container 116 can comprise an electrically conducting material, but is electrically isolated from the platform 112 by one or more non-conducting materials (not shown). The bait container 116 can be electrically coupled to the platform 112. For example, the bait container 116 can comprise a metal bowl that is configured to conduct any electrical current provide to the platform 112. Thus, the bait container 116 can be configured to also supply an electrical shock to the reptile 5.

In an embodiment, the bait container 116 is electrically coupled with the power supply 130 so that the bait container 116 can be configured to incapacitate the reptile 5. For example, the platform 112 may or may not be electrically coupled to the power supply 130, but the bait container 116 can be configured to provide electrical energy to the reptile 5. As an example, the bait container 116 can contain an electrically conducting bait, and the bait container 116 can be electrically energized such that the electrically conducting bait is energized. When a reptile 5 attempts to eat the electrically conducting bait, the reptile 5 is electrocuted based on the energy provided to the bait container 116 from the power supply 130. Thus, the bait container 116 can provide another means for electrically incapacitating the reptile 5.

The electrical trap system 100 comprises an electric trap controller 120. The electric trap controller 120 can be configured to operate the electrical trap system 100. The electrical trap controller 120 can comprise a controller and/or processor configured to operate and/or control the one or more components of the electrical trap system 100. The electric trap controller 120 can be communicatively coupled and/or electrically coupled to the one or more components of the electrical trap system 100. The electric trap controller 120 can communicate with the one or more components of the electrical trap system 100 via a wired and/or wireless communication. The electric trap controller 120 can be configured to receive information from the one or more components of the electrical trap system 100. For example, the electric trap controller 120 can receive one or more signals, communications, and/or data from the one or more components of the electrical trap system 100. The electric trap controller 120 can process the received information to determine one or more actions to take based on the received information. The electric trap controller 120 can be configured to take one or more predetermined actions based on the received information. The electric trap controller 120 can be configured to automatically take one or more actions based on the received information. The electric trap controller 120 can be configured to operate and/or control the components of the electrical trap system 100 to incapacitate the reptile 5.

The electrical trap system 100 comprises a power supply 130. The power supply 130 can be configured to provide power to one or more components of the electrical trap system 100. The power supply 130 can be configured to be weatherproof and/or waterproof such that the power supply 130 can operate in a variety of environments and/or weather conditions along with any electrical connections coupled to the power supply 130 and/or the components of the electrical trap system 100. The power supply 130 can be configured to provide electrical energy (e.g., current, voltage, etc.) to the platform 112. The power supply 130 can be configured to provide electrical energy to the platform 112 with sufficient power to incapacitate the reptile 5. The power supply 130 can be configured to communicate with the electric trap controller 120. For example, the electric trap controller 120 can send a signal to the power supply 130 indicating that the power supply 130 should provide an electrical current to the platform 112. The power supply 130 can receive the signal, and in response, the power supply 130 can be configured to provide power to the platform 112. While a single power supply 130 is shown for ease of explanation, a person of ordinary skill in the art would appreciate that the electrical trap system 100 can comprise more than one power supply 130.

The power supply 130 can be configured to provide a large amount of energy to the platform 112 over a short period of time. Stated differently, the power supply 130 can be configured to rapidly provide a significant amount of energy to the platform 112. For example, the power supply 130 can be configured to provide over 50,000 volts to the platform in microseconds. The power supply 130 can be configured to provide a large current to the platform as well. The power supply 130 can be configured to provide from several milliamperes to up to multiple amperes over a short period of time. Thus, the power supply 130 can be configured to provide a large voltage and current to the platform 112 to incapacitate the reptile 5. As will be appreciated by one skilled in the art, the power supply 130 can be designed using a plurality of different circuits and components to provide an appropriate amount of electrical energy to the platform 112 to incapacitate the reptile 5. Stated differently, the power supply 130 can be configured for specific use cases (e.g., to incapacitate a specific species of reptile 5, based on size and material of the platform 112, etc.). Accordingly, the power supply 130 can be configured to handle a plurality of reptiles 5, as well as provide power to different components of the electrical trap system 100.

The power supply 130 can comprise one or more power supplying components. The power supply 130 can comprise a battery, a super capacitor, or any device capable of providing sufficient electrical energy to the platform 112 to incapacitate the reptile 5. The power supply 130 can be a rechargeable power supply. The power supply 130 can be removable from the electrical trap system 100. For example, the power supply 130 can comprise a rechargeable battery pack that is coupled to the electrical trap system 100 via an electrical connection. The electrical connection of the power supply 130 can be disconnected from the electrical trap system 100 to allow the power supply 130 to be removed from the electrical trap system 100. Once removed, the power supply 130 can be recharged and replaced within the electrical trap system 100.

The electrical trap system 100 comprises an activation device 140. The activation device 140 can be configured to receive an input from a user via an actuation 142 to indicate that the electrical trap system 100 should activate. The actuation 142 can be any device capable of receiving an indication from a user, such as a button, a switch, etc. The activation device 140 can be communicatively coupled with the electric trap controller 120 via a wired or wireless connection. The activation device 140 can be configured to send an electrical signal to the electric trap controller 120 upon receiving the input from the user. For example, the activation device 140 can be a button that when depressed by a user, sends an electrical signal to the electric trap controller 120 to activate the electrical system 100 to incapacitate the reptile 5. The activation device 140 can be located a distance away from the electric trap controller 120. For example, the activation device 140 can be coupled to a wire of sufficient length to allow the user to be a set distance away from the platform 112 to ensure that the user does not prevent (e.g., scare) the reptile 5 from approaching the platform 112.

The activation device 140 can be configured to receive more than one input from a user prior to sending the signal to the electric trap controller 120. For example, the activation device 140 can comprise a switch and a button. The switch can function as an “arming” mechanism to prime the activation device 140 to send a signal to the electric trap controller 120. However, the activation device 140 does not send the signal to the electric trap controller 120 until the button is depressed. Thus, the activation device 140 can be configured to have one or more safety mechanisms to ensure that the electrical trap system 100 is not inadvertently activated.

The electrical trap system 100 comprises a sensor 150. The sensor 150 can be any sensor capable of detecting a signal. The electrical trap system 100 can have one or more sensors 150. The sensor 150 can be configured to detect whether the reptile 5 has come in contact with the platform 112. For example, the sensor 150 can be a capacitance and/or resistance sensor that can detect a change in the impedance of the platform 112, which would indicate that the reptile 5 has come in contact with the platform 112.

The sensor 150 can be coupled with any of the components of the electrical trap system 100 to ensure that each of the components are functioning properly. For example, each of the components of the electrical trap system 100 can have a respective sensor 150 that is configured to determine a status and/or health of the respective component. If the sensor 150 detects that one of the components is not operating as intended, the sensor 150 can transmit a signal to the electric trap controller 120 indicating a fault with the respective component. The electric trap controller 120 can receive the fault indication from the sensor 150 and determine whether the electrical trap system 100 is capable of safely functioning. For example, if the fault indicates that the power supply 130 is malfunctioning, the electric trap controller 120 can determine the electrical trap system 100 cannot operate safely and prevent the electrical trap system from operating. As another example, if the fault indicates that a backup sensor 150 is faulty, but the main sensor 150 is still operating normally, the electric trap controller 120 can determine the electrical trap system 100 is still capable of being operated normally since the fault is associated with a non-critical component. However, if the main sensor 150 and the backup sensor 150 are both indicating as being faulty, the electric trap controller 120 can determine that the electrical trap system 100 should not be operated until the sensors 150 are repaired or replaced. The electric trap controller 120 can communicate with another device (e.g., the computing device 190) to indicate the fault of the sensor 150 to a user associated with the electrical trap system 100. Thus, the user can be informed of whether or not the electrical trap system 100 is operating correctly or if there are any faults with the plurality of components of the electrical trap system 100.

The sensor 150 can be configured to be an environmental sensor to ascertain one or more environmental characteristics, such as humidity, rain, temperature, etc. The sensor 150 can provide the electric trap controller 120 with the one or more environmental characteristics. The electric trap controller 120 can utilize the one or more environmental characteristics to make one or more determinations. The electric trap controller 120 can utilize the environmental characteristics to determine how to operate the electrical trap system 100. For example, the electric trap controller 120 can utilize the environmental characteristics to determine whether the amount of energy provided by the power supply 130 should be increased or decreased to ensure that the reptile 5 is incapacitated by the electrical energy supplied to the platform 112. As an example, if the sensor 150 indicates that the humidity is high and the temperature is also high, the amount of energy that needs to be provided to the platform 112 may need to be higher than if the humidity is low and the temperature is low due to the change in conductance of the platform 112.

The electric trap controller 120 can make one or more safety determinations based on the one or more environmental characteristics. For example, if the sensor 150 determines that it is raining, the sensor 150 can send a signal to the electric trap controller 120 indicating that it is raining. The electric trap controller 120 can determine that based on the amount of rain, the electrical trap system 100 should not be activated due to the risk of damage to the electrical trap system 100. As another example, if the sensor 150 indicates a significantly high temperature, the electric trap controller 120 can determine the electrical trap system 100 should not be activated due to a risk of causing a fire or damage to the one or more components of the electrical trap system 100. In this manner, the electric trap controller 120 is capable of making one or more safety determinations regarding the operation of the electrical trap system 100 based on one or more environmental characteristics around the electrical trap system 100.

The electrical trap system 100 comprises a camera 160. The camera 160 can be any camera capable of taking photos and/or videos of the environment around the camera 160. The camera 160 can be configured as a digital camera capable of sending one or more photos and/or videos to the electric trap controller 120. The electric trap controller 120 can utilize the photos and/or videos from the camera 160 to make one or more determinations. The electric trap controller 120 can be configured to utilize image processing to identify one or more objects within the photos and/or videos from the camera 160. For example, the electric trap controller 120 can be configured to determine whether the reptile 5 is located on the platform 112 by processing the photos and/or videos to identify if a reptile 5 is located on the platform 112. If the electric trap controller 120 determines that a reptile 5 is located on the platform based on the image processing, the electric trap controller 120 can be configured to provide electrical power to the platform 112 to incapacitate the reptile 5.

The electric trap controller 120 can be configured to prevent one or more actions based on the photos and/or videos provided by the camera 160. For example, if the electric trap controller 120 determines that there is an object, animal, and/or person on the platform 112 that is not the reptile 5, the electric trap controller 120 can prevent the electrical trap system 100 from activating. That is, if the activation device 140 sends a signal to the electric trap controller 120 to incapacitate the reptile 5, the electric trap controller 120 can utilize the camera 160 to determine whether it is safe to do so (e.g., there are no other objects, animals, and/or persons that could be injured if the platform 112 is electrified). If the electric trap controller 120 determines that it is not safe to incapacitate the reptile 5, the electric trap controller 120 can be configured to transmit an error message indicating that it is not safe to incapacitate the reptile 5.

The electric trap controller 120 can be configured to utilize the camera 160 to provide the photos and/or videos provided by the camera 160 to the computing device 190. The electric trap controller 120 can receive the photos and/or videos from the camera 160 and provide them to the computing device 190. For example, a user could utilize the computing device 190 to review the photos and/or videos captured by the camera 160. The user could review the photos and/or videos in real time or recall them from stored memory.

The electric trap controller 120 can utilize the camera 160 to make one or more determinations about the electrical trap system 100. The camera 160 can be configured to capture the various components of the electrical trap system 100. The camera 160 can send the captured photos and/or videos to the electric trap controller 120 that can utilize image processing to make a determination as to the status of the components of the electrical trap system 100. For example, the camera 160 can capture images that indicate a component of the electrical trap system 100 is damaged or not functioning properly. The camera 160 can provide these images to the electric trap controller 120 that can determine that the component is damaged or not functioning properly. The electric trap controller 120 can take one or more steps based on this determination, such as not activating the electrical trap system 100, communicating to another device a communication that the component is damaged or not functioning properly so that a user can take one or more actions to fix the damaged component, etc.

The electric trap controller 120 can utilize the camera 160 to make one or more determinations about the environment surrounding the electrical trap system 100. Similar to the sensor 150, the camera 160 can provide captured images (e.g., photos, videos, etc.) to the electric trap controller 120 to allow the electric trap controller 120 to make one or more determinations and/or actions based on the captured images. For example, the camera 160 can capture images of one or more reptiles in the area around the electrical trap system 100. The electric trap controller 120 can utilize image processing to determine the number of reptiles in the area, as well as the day and/or time that the reptiles are most likely to be present in the area immediately surrounding the electrical trap system 100. The electrical trap controller 120 can utilize this information to make one or more determinations on how to best operate the electrical trap system 100. As an example, the electric trap controller 120 can utilize the camera 160 to determine a time that the largest number of reptiles 5 are present in the vicinity around the electrical trap system 100 to determine the best time to attempt to incapacitate as many reptiles 5 as possible. As another example, the electric trap controller 120 can utilize the information to determine if electrical trap system 100 has been placed in an poor location due to the lack of reptiles 5 in the vicinity of the electrical trap system 100. The electric trap controller 120 can notify a user (e.g., via the speaker 170, the warning device 180, and/or the computing device 190) that no reptiles 5 have been identified in the area around the electrical trap system 100 so that the user can relocate the electrical trap system 100 to a location that has additional reptiles 5.

The electric trap controller 120 can utilize the camera 160 to make one or more determinations about whether the electrical trap system 100 was successful in incapacitating the reptile 5. For example, the camera 160 can capture images of one or more reptiles on the platform 112. The electric trap controller 120 can utilize image processing to determine if, after applying electrical energy to the platform 112, the reptiles 5 were incapacitated. The electrical trap controller 120 can utilize this information to make one or more determinations on how to best operate the electrical trap system 100. As an example, the electric trap controller 120 can utilize the camera 160 to determine that a reptile 5 was not fully incapacitated. Based on this information, the electric trap controller 120 can provide additional energy to the platform 112 in an attempt to further incapacitate the reptile 5. The electric trap controller 120 can utilize the information of whether or not a reptile 5 was incapacitated to further improve the operation of the electrical trap system 100. For example, the electric trap controller 120 can utilize a higher amount of electrical energy in the future based on the number and/or size of the reptiles 5 to ensure that all reptiles 5 on the platform 112 are incapacitated. As another example, the electric trap controller 120 can vary the amount of electrical power provided to the platform 112 based on the number of reptiles 5 on the platform 112. If the number of reptiles 5 is one, the electric trap controller 120 can provide a lower amount of energy versus if there are more than one reptiles 5 on the platform 112. The electric trap controller 120 could also use the sensor 150 to make a determination on how much energy to provide to the platform 112. Thus, in this manner, the electric trap controller 120 is capable of modifying the amount of electrical energy 112 provided to the platform based on the number of reptiles 5.

The electrical trap system 100 comprises a speaker 170. The speaker 170 can be configured to provide one or more sounds in the area surrounding the electrical trap system 100. The speaker 170 can be configured to provide one or more messages from the electric trap controller 120. The electric trap controller 120 can utilize the speaker 170 to transmit a message to a user of the electrical trap system 100. The electric trap controller 120 can utilize the speaker 170 to send a status of any of the one or more components of the electrical trap system 100. For example, the electric trap controller 120 can indicate to a user a fault with the electrical trap system 100 so that the user can take one or more actions to address the fault. The speaker 170 can be configured to provide a warning that the electrical trap system 100 is about to activated. The warning can be a spoken warning such as “Warning! Stand clear of the electrical trap system. The electrical trap system is about to be activated and will deliver an electric shock.” The warning can be a siren or other noise to indicate to persons and/or animals nearby that the electrical system 100 is going to be activated. The electric trap controller 120 can be configured to activate the speaker 170 to broadcast a warning after receiving a signal from the activation device 140 to activate the electrical trap system 100.

The electrical trap system 100 comprises a warning device 180. The warning device 180 can be a light and/or siren designed to provide a general warning of danger. The warning device 180 can be utilized by the electric trap controller 120 to provide a warning prior to providing electrical current to the platform 112 to incapacitate the reptile 5. The warning device 180 can be configured as a display device capable of displaying one or more messages from the electric trap controller 120. The warning device 180 can be configured to display one or more messages regarding the status of one or more components of the electrical trap system 100. For example, if there is a fault in one of the components, the electric trap controller 120 can transmit a message to the warning device 180 to indicate to a user the fault in the component. Thus, while the warning device 180 is illustrated as a siren, the warning device 180 can be configured as a display to provide more detailed warnings and/or messages regarding the electrical trapping system 100.

The electrical trap system 100 comprises a computing device 190. The computing device 190 is communicatively and/or electrically coupled with the electric trap controller 120. The computing device 190 is not required for the electrical trap system 100. That is, the electrical trap system 100 is fully capable of operating without the computing device 190. In an embodiment, the electric trap controller 120 comprises the capabilities of the computing device 190. In another embodiment, the computing device 190 comprises the capabilities of the electric trap controller 120. For example, the electric trap controller 120 can have reduced capabilities to reduce the cost and complexity of the electric trap controller 120, and the computing device 190 can be configured to handle the majority of the operations necessary for the electrical trap system 100 to operate. In this example, the computing device 190 would do the majority of processing required for operating the electrical trap system 100, while the electric trap controller 120 simply executes the commands of the computing device 190.

The computing device 190 can be a smartphone, a computer, or other electrical device with processing and communication capabilities. The computing device 190 may include components such as, at least one of each of a processing device, and a memory device for processing use, such as random-access memory (RAM), and read-only memory (ROM). The computing device 190 can also include a storage device including at least one non-transitory storage medium, such as a Microdrive, for long-term, intermediate-term, and short-term storage of computer-readable instructions for execution by the computing device 190. For example, the instructions can include instructions for an operating system and various applications or programs. The storage device can store various other data, which can include, as non-limiting examples, cached data, data related to incapacitated animals, data related to the electrical trapping system and/or components, communication data, and files such as those for user accounts, user profiles, files downloaded or received from other devices, and other data items preferred by the user or required or related to any or all of the applications or programs. The computing device 190 can comprise a display and an input.

The computing device 190 can be communicatively coupled with one or more other computing devices 190 (not shown). The computing device 190 can utilize a wired or wireless network to communicate with the one or more other computing devices 190. For example, the computing device 190 can utilize wireless communications to transmit one or more messages to another computing device that is remote from the electrical trap system 100. The computing device 190 can provide to, and receive from, the another computing device information associated with the electrical trap system 100. For example, the computing device 190 can send a transmission to the another computing device indicating one or more faults associated with the electrical trap system 100 to notify a user of the one or more faults so that the user can take one or more actions to address the one or more faults associated with the electrical trap system 100. As another example, the another computing device can remotely control the electrical trap system 100. In this example, the computing device 190 provides the another computing device with one more communications indicating the operational status of the electrical system 100, and whether the reptile 5 is located on the platform 112 to be shocked by the electrical trap system 100. The another computing device can utilize the information provided by the computing device 190 to determine whether to activate the electrical trap system 100, and upon doing so, the another computing device transmits a message to the computing device 190 indicating that the electrical trap system 100 should activate. In this manner, the electrical trap system 100 is capable of being remotely controlled.

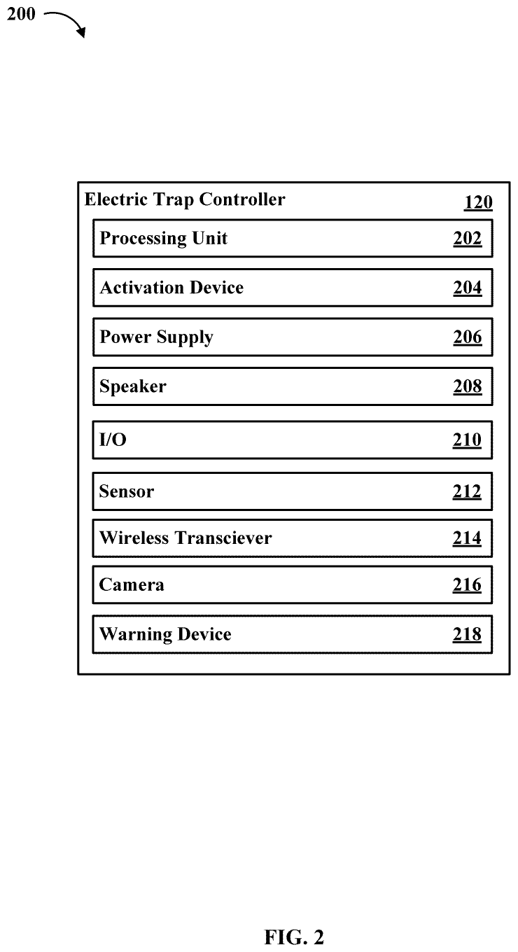

FIG. 2 illustrates a diagram of an electric system 200, according to at least one embodiment. In an embodiment, the electric trap controller 120 comprises the same capabilities and functionality of the electric trap controller 120 of FIG. 1. The electric trap controller 120 comprises a processing unit 202, an activation device 204, a power supply 206, a speaker 208, an Input/Output (I/O) interface 210, a sensor 212, a wireless transceiver 214, a camera 216, and a warning device 218. The electric trap controller 120 can be configured to control components of an electrical trap system (e.g., the electrical trap system 100 of FIG. 1).

The processing unit 202 comprises a processing device configured to process data. The processing unit 202 can comprise, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing unit 202, while in other embodiments methods and functions described herein include cloud-based computing in whole or in part such that the processing unit 202 facilitates local operations including, as non-limiting examples, communication, data transfer, and user inputs and outputs such as receiving commands from and providing displays. The processing unit 202 also comprises a memory unit for processing use, such as random-access memory (RAM), and read-only memory (ROM). The processing unit 202 also comprises a storage unit including at least one of a non-transitory storage medium, such as a Microdrive, for long-term, intermediate-term, and short-term storage of computer-readable instructions for execution by the processing unit 202. For example, the instructions can include instructions for an operating system and various applications or programs. The storage unit can store various other data items, which can include, as non-limiting examples, cached data, user files such as those for pictures, audio and/or video recordings, files downloaded or received from other devices, and other data items preferred by the user, such as user preferences for operating the electric trap controller 120 or the electric trap system 100 of FIG. 1, or required or related to any or all of the applications or programs.

The memory unit is operatively coupled to the processing unit 202. As used herein, memory includes any computer readable medium to store data, code, or other information. The memory unit may include volatile memory, such as volatile Random Access Memory (RAM) including a cache area for the temporary storage of data. The memory unit may also include non-volatile memory, which can be embedded and/or may be removable. The non-volatile memory can additionally or alternatively include an electrically erasable programmable read-only memory (EEPROM), flash memory or the like.

According to various embodiments, the memory unit and storage unit may be combined into a single storage medium. The memory unit and storage unit can store any of a number of applications which comprise computer-executable instructions and code executed by the processing unit 202 to implement the functions of the electric trap controller 120 described herein.

The processing unit 202, and other processors described herein, generally include circuitry for implementing communication and/or logic functions of the electric trap controller 202. For example, the processing unit 202 may include a digital signal processor, a microprocessor, and various analog to digital converters, digital to analog converters, and/or other support circuits. Control and signal processing functions of the electric trap controller 202 are allocated to the processing unit 202. The processing unit 202 thus may also include the functionality to encode and interleave messages and data prior to modulation and transmission. The processing unit 202 can additionally include an internal data modem. Further, the processing unit 202 may include functionality to operate one or more software programs, which may be stored in the memory unit, or in the storage unit.

The processing unit 202 can include components such as, at least one of each of a processing device, and a memory device for processing use, such as random-access memory (RAM), and read-only memory (ROM). The computing device 190 can also include a storage device including at least one non-transitory storage medium, such as a Microdrive, for long-term, intermediate-term, and short-term storage of computer-readable instructions for execution by the computing device 190. For example, the instructions can include instructions for an operating system and various applications or programs. The storage device can store various other data, which can include, as non-limiting examples, cached data, data related to incapacitated animals, data related to the electrical trapping system and/or components, communication data, and files such as those for user accounts, user profiles, files downloaded or received from other devices, and other data items preferred by the user or required or related to any or all of the applications or programs.

The processing unit 202, in various examples, can operatively perform calculations, can process instructions for execution, and can manipulate information. The processing unit 202 can execute machine-executable instructions stored in the storage unit and/or memory unit to thereby perform methods and functions as described or implied herein to operate the electrical trap system 100 as would be understood by one of ordinary skill in the art to which the subject matters of these descriptions pertain.

The electric trap controller 120 comprises an activation device 204. In an embodiment, the activation device 204 comprises the same capabilities and functionality of the activation device 140 of FIG. 1. The activation device 204 can be configured to receive an input from a user via an actuation to indicate that the electrical trap system should activate. The actuation can be any device capable of receiving an indication from a user, such as a button, a switch, an input device, a touch screen, etc. The activation device 204 can be configured to send an electrical signal to the processing unit 202 upon receiving the input from the user. For example, the activation device 204 can be a button that when depressed by a user, sends an electrical signal to the processing unit 202 to activate the electrical system to incapacitate a reptile. The activation device 204 can be configured to receive more than one input from a user prior to sending the signal to the processing unit 202. For example, the activation device 204 can comprise a switch and a button. The switch can function as an “arming” mechanism to prime the activation device 204 to send a signal to the electric processing unit 202. However, the activation device 204 does not send the signal to the processing unit 202 until the button is depressed. Thus, the activation device 204 can be configured to have one or more safety mechanisms to ensure that the electrical trap controller 120 is not inadvertently activated.

The electric trap controller 120 comprises a power supply 206. In an embodiment, the power supply 206 comprises the same capabilities and functionality of the power supply 130 of FIG. 1. The power supply 206 can be configured to provide power to one or more components of the electrical trap controller 120 100. The power supply 206 can be configured to provide an electrical current to a platform (e.g., the platform 112 of FIG. 1). The power supply 206 can be configured to provide an electrical current to the platform with sufficient power to incapacitate a reptile. The power supply 206 can be configured to communicate with the processing unit 202. For example, processing unit 202 can send a signal to the power supply 206 indicating that the power supply 206 should provide an electrical current to the platform. The power supply 206 can receive the signal, and in response, the power supply 206 can be configured to provide power to the platform. While a single power supply 206 is shown for ease of explanation, a person of ordinary skill in the art would appreciate that the electric trap controller 120 can comprise more than one power supply 206.

The power supply 206 can comprise one or more power supplying components. The power supply 206 can comprise a battery, a super capacitor, or any device capable of providing sufficient electrical power to the electric trap controller 120, as well as to the platform to incapacitate the reptile. The power supply 206 can be a rechargeable power supply. The power supply 206 can be removable from the electric trap controller 120. For example, the power supply 206 can comprise a rechargeable battery pack that is coupled to the electric trap controller 120 via an electrical connection. The electrical connection of the power supply 206 can be disconnected from the electric trap controller to allow the power supply 206 to be removed from the electric trap controller. Once removed, the power supply 206 can be recharged and replaced within the electric trap controller 120.

The electric trap controller 120 comprises a speaker 208. In an embodiment, speaker 208 comprises the same capabilities and functionality of the speaker 170 of FIG. 1. The speaker 208 can be configured to provide one or more sounds in the area surrounding the electric trap controller 120. The speaker 208 can be configured to provide one or more messages from the electric trap controller 120. The electric trap controller 120 can utilize the speaker 208 to transmit a message to a user of the electric trap controller 120. The electric trap controller 120 can utilize the speaker 208 to send a status of any of the one or more components of the electric trap controller 120. For example, the electric trap controller 20 can indicate to a user a fault with one of the components of the electric trap controller 120 so that the user can take one or more actions to address the fault. The speaker 208 can be configured to provide a warning that the electric trap controller is about to activated. The warning can be a spoken warning such as “Warning! Stand clear of the electrical trap system. The electrical trap system is about to be activated and will deliver an electric shock.” The warning can be a siren or other noise to indicate to persons and/or animals nearby that the electric trap controller 120 is going to be activated. The electric trap controller 20 can be configured to activate the speaker 208 to broadcast a warning after receiving a signal from the activation device 204 to activate the electric trap controller.

The electric trap controller 120 comprises an I/O 210. The I/O 210 refers to, including, or operatively coupled with, one or more input devices and/or one or more output devices, which are operatively coupled to the electric trap controller 120. The I/O 210 may include input/output circuitry that may operatively convert analog signals and other signals into digital data, or may convert digital data to another type of signal. For example, the input/output circuitry may receive and convert physical contact inputs, physical movements, or auditory signals to digital data. Once converted, the digital data may be provided to the processing unit 202. The I/O 210 may also include a display (e.g., a liquid crystal display (LCD), light emitting diode (LED) display, or the like), which can be, as a non-limiting example, a presence-sensitive input screen (e.g., touch screen or the like), which serves both as an output device, by providing graphical and text indicia and presentations for viewing by one or more user, and as an input device, by providing virtual buttons, selectable options, a virtual keyboard, and other indicia that, when touched, control the electric trap controller 120 by user action. The user input devices, which allow the electric trap controller 120 to receive data and actions such as button manipulations and touches from a user may include any of a number of devices allowing the electric trap controller to receive data from a user, such as a keypad, keyboard, touch-screen, touchpad, microphone, mouse, joystick, other pointer device, button, soft key, infrared sensor, and/or other input device(s).

The electric trap controller 120 comprises a sensor 212. In an embodiment, the sensor 212 comprises the same capabilities and functionality of the sensor 150 of FIG. 1. The sensor 212 can be any sensor capable of detecting a signal. The electric trap controller 120 can have one or more sensors 212. The sensor 212 can be configured to detect whether a reptile has come in contact with a platform coupled to the electric trap controller 120. For example, the sensor 212 can be a capacitance and/or resistance sensor that can detect a change in the impedance of the platform, which would indicate that the reptile has come in contact with the platform.

The sensor 212 can be coupled with any of the components of the electric trap controller 120 to ensure that each of the components are functioning properly. For example, each of the components of the electric trap controller 120 can have a respective sensor 212 that is configured to determine a status and/or health of the respective component. If the sensor 212 detects that one of the components is not operating as intended, the sensor 212 can transmit a signal to the processing unit 202 indicating a fault with the respective component. The processing unit 202 can receive the fault indication from the sensor 212 and determine whether the electric trap controller 120 is capable of safely functioning. For example, if the fault indicates that the power supply 206 is malfunctioning, the processing unit 202 can determine the electric trap controller 120 cannot operate safely and prevent the electrical trap system (e.g., the electrical trap system 100 of FIG. 1) from operating. As another example, if the fault indicates that a backup sensor 212 is faulty, but the main sensor 212 is still operating normally, the processing unit 202 can determine the electric trap controller 120 is still capable of being operated normally since the fault is associated with a non-critical component. However, if the main sensor 212 and the backup sensor 212 are both indicating as being faulty, the processing unit 202 can determine that the electric trap controller 120 should not be operated until the sensors 212 are repaired or replaced.

The sensor 212 can be configured to be an environmental sensor to ascertain one or more environmental characteristics. The sensor 212 can provide the processing unit 202 with the one or more environmental characteristics, and the processing unit 202 can make one or more determinations based on the one or more environmental characteristics. For example, if the sensor 212 determines that it is raining, the sensor 212 can send a signal to the processing unit 202 indicating that it is raining. The processing unit 202 can determine whether or not the electric trap controller 120 should be activated while it is raining

The electric trap controller 120 comprises a wireless transceiver 214. The wireless transceiver 214 may include digital signal processing circuitry and may provide two-way communications and data exchanges, for example wirelessly via wireless communications, and for an additional or alternative example, via wired or docked communication by mechanical electrically conductive connector. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless transceiver 214, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the I/O 210 for wired connections such by USB, Ethernet, and other physically connected modes of data transfer.

The processing unit 202 is configured to use the wireless transceiver 214 as, for example, a network interface to communicate with one or more other devices on a network. In this regard, the wireless transceiver 214 utilizes an antenna operatively coupled to a transmitter and a receiver. The processing unit 202 is configured to provide signals to and receive signals from the wireless transceiver 214. The signals may include signaling information in accordance with the air interface standard of the applicable cellular system of a wireless telephone network. In this regard, the electric trap controller 120 can be configured to operate with one or more air interface standards, communication protocols, modulation types, and access types.

The wireless transceiver 214 can be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The electric trap controller 120 comprises a camera 216. In an embodiment, the camera 216 comprises the same capabilities and functionality of the camera 160 of FIG. 1. The camera 216 can be any camera capable of taking photos and/or videos of the environment around the camera 216. The camera 216 can be configured as a digital camera capable of sending one or more photos and/or videos to the processing unit 202 for processing. The processing unit 202 can utilize the photos and/or videos from the camera 216 to make one or more determinations. The processing unit 202 can be configured to utilize image processing to identify one or more objects within the photos and/or videos from the camera 216. For example, the processing unit 202 can be configured to determine whether a reptile is located on a platform associated with the electric trap controller 120 by processing the photos and/or videos to identify if a reptile is located on the platform. If the processing unit 202 determines that a reptile is located on the platform based on the image processing, the processing unit 202 can be configured to provide an electric shock to the platform to incapacitate the reptile.

The processing unit 202 can be configured to prevent one or more actions based on the photos and/or videos provided by the camera 216. For example, if the processing unit 202 determines that there is an object, animal, and/or person on the platform that is not the reptile, the processing unit 202 can prevent the electric trap controller 120 from activating. That is, if the activation device 204 sends a signal to the processing unit 202 to incapacitate the reptile, the processing unit 202 can utilize the camera 216 to determine whether it is safe to do so (e.g., there are no other objects, animals, and/or persons that could be injured if the platform is electrified). If the processing unit 202 determines that it is not safe to incapacitate the reptile, the processing unit 202 can be configured to transmit an error message indicating that it is not safe to incapacitate the reptile.

The electric trap controller 120 comprises a warning device 218. In an embodiment, the warning device 218 comprises the same capabilities as the warning device 180 of FIG. 1. The warning device 218 can be a light and/or siren designed to provide a general warning of danger. The warning device 218 can be utilized by the processing unit 202 to provide a warning prior to providing electrical current to the platform to incapacitate the reptile. The warning device 218 can be configured as a display device capable of displaying one or more messages from the electric trap controller 120. The warning device 218 can be configured to display one or more messages regarding the status of one or more components of the electric trap controller 120. For example, if there is a fault in one of the components, the processing unit 202 can transmit a message to the warning device 218 to indicate to a user the fault in the component.

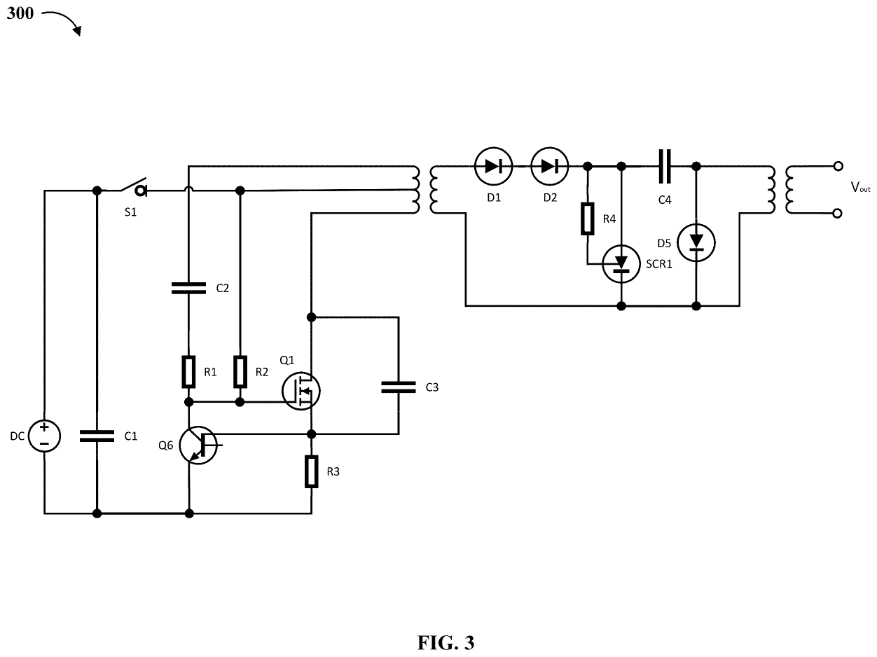

FIG. 3 illustrates an electrical diagram of an electric trap circuit 300, according to at least one embodiment. The electric trap circuit 300 is configured to provide a short pulse on an output to incapacitate an animal. The electric trap circuit 300 can be configured to provide an optimum amount of voltage and current to incapacitate the animal, without providing too much voltage and/or current to avoid causing damage to an electrical trap system (e.g., the electrical trap system 100 of FIG. 1) or use more power than necessary to effectively incapacitate the animal. The electric trap circuit 300 can be configured based on one or more requirements for an electrical trap system (e.g., the electrical trap system 100 of FIG. 1) and/or the animal desiring to be incapacitated (e.g., the reptile 5 of FIG. 1). The components of the electric trap circuit 300 can be selected based on these one or more requirements. The requirements can be based on the size of a specific trap and/or the size of the animal needing to be incapacitated. For example, the electric trap circuit 300 can provide a high voltage with a low current to incapacitate and/or kill an animal. As will be appreciated by one skilled in the art, there are a plethora of ways to design the electric trap circuit 300, as well as choose varying components, that provides a high voltage with a low current and this is merely an exemplary embodiment. Accordingly, the invention should not be limited to this specific design.

The electric trap circuit 300 comprises a power supply, a plurality of resistors, a plurality of capacitors, two transistors, as well as two transformers. The electric trap circuit 300 increases the input voltage via the transformers and provides high voltage potential at the output. The voltage and/or current of the output can be increased or decreased based on the one or more components of the electric trap circuit 300. The electric trap circuit 300 also comprises an activation switch to provide the input voltage to a first transformer to generate the output. The electric trap circuit 300 is configured to produce a sufficient amount of energy to electrically incapacitate an animal (e.g., the reptile 5 of FIG. 1).

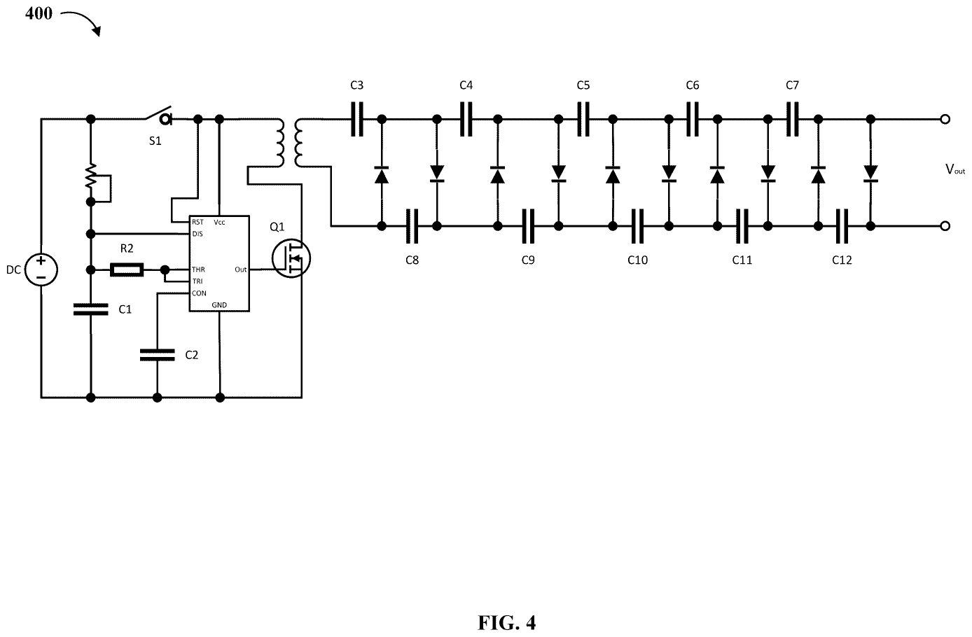

FIG. 4 illustrates an electrical diagram of an electric trap circuit 400, according to at least one embodiment. The electric trap circuit 400 is configured to provide a short pulse on an output to incapacitate an animal. The electric trap circuit 400 can be configured to provide an optimum amount of voltage and current to incapacitate the animal, without providing too much voltage and/or current to avoid causing damage to an electrical trap system (e.g., the electrical trap system 100 of FIG. 1) or use more power than necessary to effectively incapacitate the animal. The electric trap circuit 400 can be configured based on one or more requirements for an electrical trap system (e.g., the electrical trap system 100 of FIG. 1) and/or the animal desiring to be incapacitated (e.g., the reptile 5 of FIG. 1). The components of the electric trap circuit 400 can be selected based on these one or more requirements. The requirements can be based on the size of a specific trap and/or the size of the animal needing to be incapacitated. For example, the electric trap circuit 400 can provide a high voltage with a low current to incapacitate and/or kill an animal. As will be appreciated by one skilled in the art, there are a plethora of ways to design a circuit, as well as choose varying components, that provides a high voltage with a low current and this is merely an exemplary embodiment. Accordingly, the invention should not be limited to this specific design.

The electric trap circuit 400 comprises an integrated circuit configured to produce an oscillating (e.g., AC) electric signal. The electric signal is provided to a transformer that increases the voltage and provides the power to a plurality of capacitors and diodes that build up the charge to produce a high voltage output with a low current. The electric trap circuit 400 comprises an activation switch to provide a signal to the integrated circuit to indicate the integrated circuit should produce the electric signal. The electric trap circuit 400 is configured to produce a sufficient amount of energy to electrically incapacitate an animal (e.g., the reptile 5 of FIG. 1).

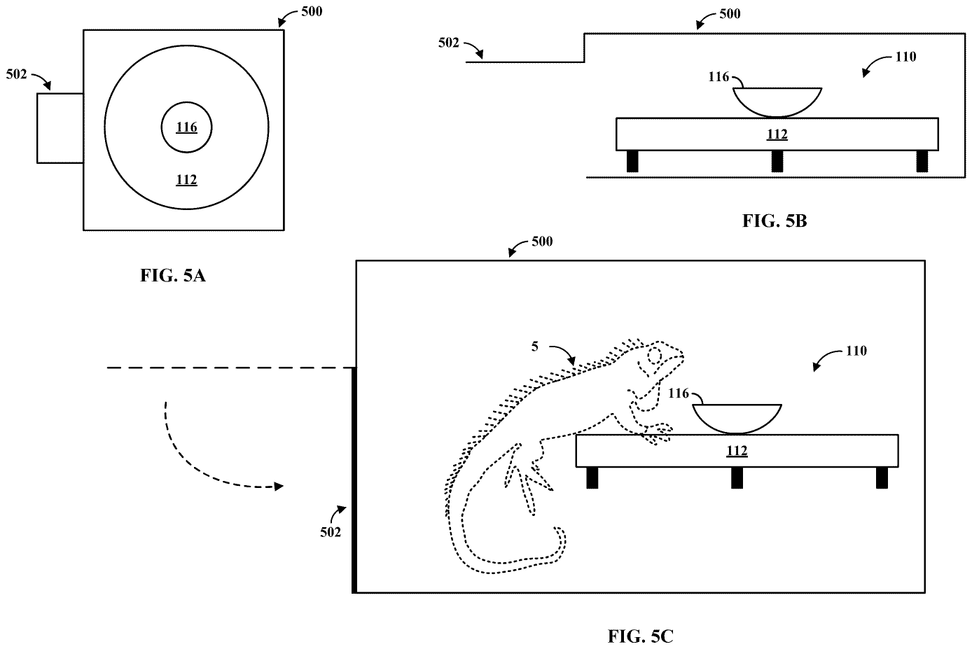

FIGS. 5A-5C illustrate an electrical trap system with a safety enclosure 500, in accordance with an embodiment of the present invention. The safety enclosure 500 can be utilized with the electrical trap system 100 of FIG. 1 and/or the electric trap controller 120 of FIG. 2. The safety enclosure 500 completely surrounds the platform 112. The safety enclosure 500 has a door 502 that is configured to open and close. The door 502 can be coupled to a mechanical and/or electrical device that can move the door 502 from an open position to a closed position. For example, the door 502 can be coupled to an actuator that when in a first position opens the door 502, and when the actuator is in a second position, closes the door 502. The combination of the safety enclosure 500 and the door 502 can force any animals desiring to reach the bait container 116 to utilize the entrance created by the open door 504. FIG. 5A illustrates a top-down view of the platform 112 of FIG. 1, and the bait container 116 of FIG. 1 surrounded by the safety enclosure 500 with the door 502 in an open position. FIG. 5B illustrates a side perspective of the platform 112 of FIG. 1, and the bait container 116 of FIG. 1. FIG. 5B shows the opening in the safety enclosure 500 created by the door 502 being in the open position. FIG. 5C illustrates the door 502 in a closed position with the reptile 5 within the safety enclosure 500. In an embodiment, the door 502 closes upon detecting that the reptile 5 has entered the safety enclosure 500. The door 502 can close automatically or manually. The door 502 can be an electrically controlled door that can be set in an open or closed position based on a signal received from an electric controller (e.g., the electrical trap controller 120 of FIG. 1 and FIG. 2). For example, the electric controller can receive one or more signals (e.g., from a sensor or camera) that indicates the reptile 5 has entered the safety enclosure 500 and is located on the platform 112. The electric controller can send a signal and/or communication to the door 502 to have the door close to trap the reptile 5 within the safety enclosure 500. The electric controller can also utilize the door 502 to ensure no additional animals enter the safety enclosure prior to an electric shock being delivered to the platform 112. The electric controller can transmit a signal and/or communication to the door 502 to open after the door 502 has been shut in order to release any animals that were inadvertently trapped within the safety enclosure 502. Accordingly, the electrical trapping system can utilize the safety enclosure 500 and the door 502 to increase the safety of incapacitating the reptile 5.

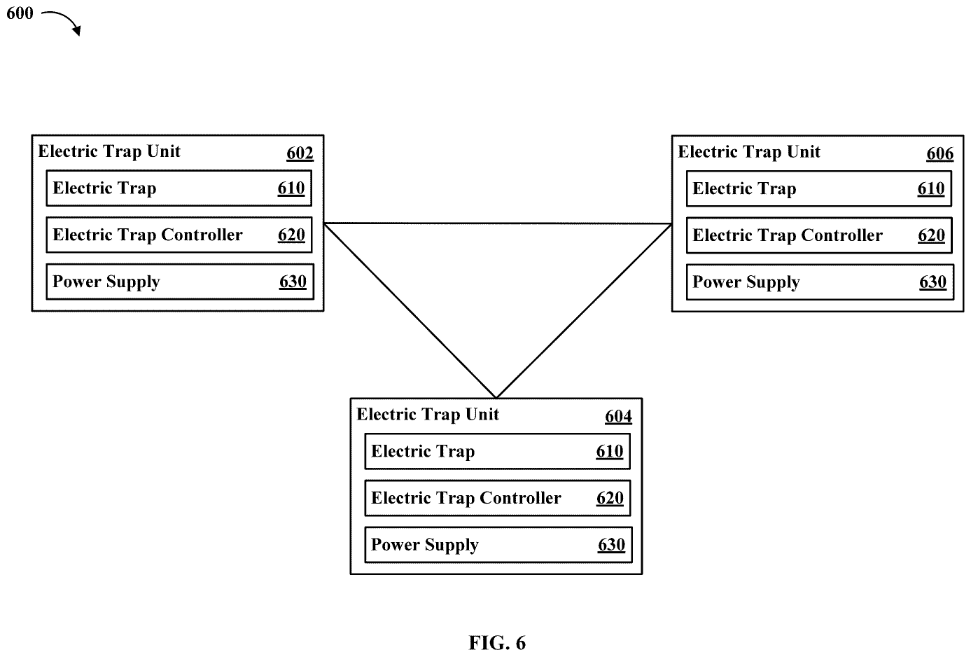

FIG. 6 illustrates an electrical trap system 600, in accordance with an embodiment of the present invention. The electrical trap system 600 comprises three electric trap units 602, 604, 606 (e.g., the electric trap unit 120 of FIG. 1 and FIG. 2). The electric trap units 602, 604, 606 comprise respective electric traps 610 (e.g., the electric trap 110 of FIG. 1), electric trap controllers 620 (e.g., electric trap controller 120 of FIG. 1 and FIG. 2), and power supplies 630 (e.g., power supply 130 of FIG. 1, power supply 206 of FIG. 2). The electric trap units 602, 604, 606 can be configured to operate independently of one another. The electric trap units 602, 604, 606 can be in communication with one another via the electric trap controller units 620. The electric trap units 602, 604, 606 can communicate the status of each of the respective electric trap unit to the other electric trap units. The electric trap units 602, 604, 606 can coordinate on activating the electric trap 610 and/or power supply 630. For example, the electric trap units 602, 604, 606 may all be set out in a similar area due to a large presence of reptiles. The electric trap units 602, 604, 606 can be configured to activate at approximately the same time in order to incapacitate as many reptiles as possible without scaring off the remaining reptiles. Accordingly, the electric trap units 602, 604, 606 can coordinate their operation to ensure the electric trap units 602, 604, 606 are as effective as possible when attempting to incapacitate a large number of reptiles. While three electric trap units were shown for ease of explanation, a person of ordinary skill in the art would appreciate that any number of electric trap units can be combined and operate in unison.

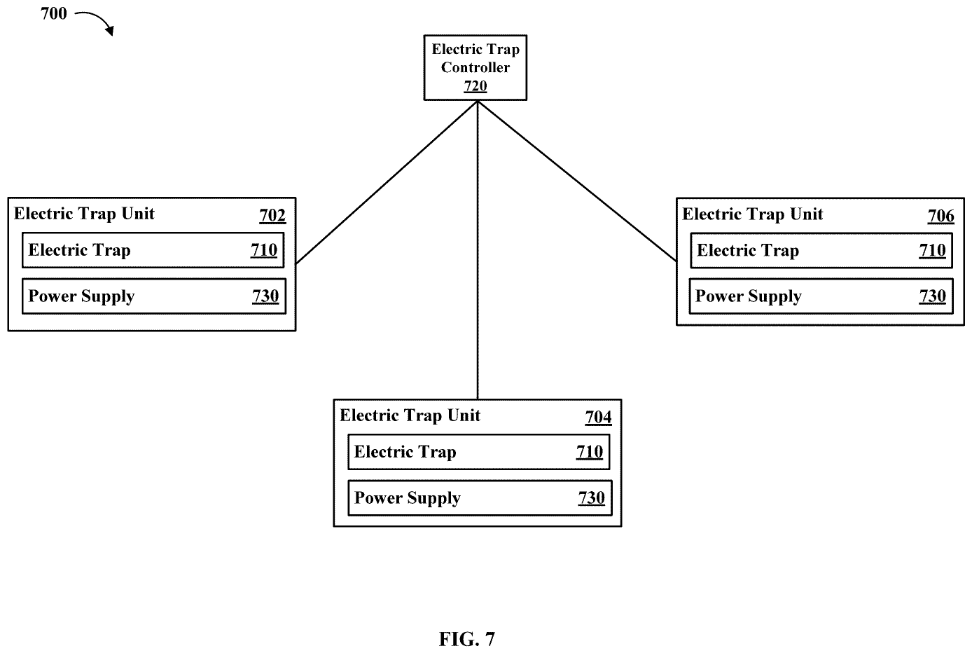

FIG. 7 illustrates an electrical trap system 700, in accordance with an embodiment of the present invention. The electrical trap system 700 comprises an electric trap unit 702, an electric trap unit 704, and an electric trap unit 706 (e.g., the electric trap unit 120 of FIG. 1 and FIG. 2). The electric trap units 702, 704, 706 each have respective electric traps 710 (e.g., the electric trap 110 of FIG. 1) and power supplies 730 (e.g., power supply 130 of FIG. 1, power supply 206 of FIG. 2). The electrical trap system 700 comprises an electric trap controller 720 (e.g., electric trap controller 120 of FIG. 1 and FIG. 2). The electrical trap controller 720 controls the electric trap units 702, 704, 706. That is, the electrical trap controller 720 sends and receives signals between each of the electric trap units 702, 704, 706 to control their respective operation. The electrical trap controller 720 can selectively activate any component of the electric trap units 702, 704, 706. For example, the electrical trap controller 720 can activate the electric trap unit 706 without activating electric trap units 702, 704. Thus, the electrical trap system 700 has a centralized controller (e.g., electric trap controller 720) that can control a plurality of electric trap units (e.g., electric trap units 702, 704, 706). The electric trap controller 720 can communicate with a computing device (e.g., the computing device 190 of FIG. 1), and the computing device can provide one or more command signals to the electric trap controller 720. Thus, the electrical trap system 700 can be controlled by a computing device. The computing device can be located remotely or co-located with the electric trap controller 720. For example, the computing device can communicate with the electrical trap system 700 via the electric trap controller 720, either wired or wirelessly, to operate the electric trap units 702, 704, 706. Accordingly, a user of the electrical trap system 700 can operate and/or activate the electrical trap system 700 from a remote location without being in close proximity to the electrical trap system 700. While not shown for ease of explanation, the electric trap units 702, 704, 706 can each comprise a respective electric trap controller 720 that communicates with the computing device, similar to the system 600 of FIG. 6.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. An electrical trapping system, comprising:
an electrically conducting platform isolated from ground via one or more supports, wherein the electrically conducting platform comprises a primarily circular shape;
a power supply coupled to the electrically conducting platform; and
an electric trap controller coupled to the power supply, wherein the electric trap controller is configured to cause the power supply to discharge an electrical charge to the electrically conducting platform to incapacitate an animal electrically coupled with the electrically conducting platform.

2. The electrical trapping system according to claim 1, further comprising an activation device configured to cause the electric trap controller to cause the power supply to discharge the electrical charge to the electrically conducting platform, and a bait container located on a surface of the electrically conductive platform, wherein the bait container is configured to store bait intended to attract one or more animals.

3. The electrical trapping system according to claim 1, further comprising a sensor coupled with the electric trap controller, wherein the sensor is configured to provide one or more signals to the electric trap controller regarding a status of at least one characteristic of the power supply, the electrically conducting platform, and the electric trap controller.

4. The electrical trapping system according to claim 1, further comprising a camera configured to capture one or more images or videos, wherein the camera is configured to provide the one or more images or videos to the electric trap controller, wherein the electric trap controller is configured to perform image processing on the images or videos, and wherein the electric trap controller is configured to take one or more actions based on the image processing.

5. The electrical trapping system according to claim 1, further comprising a speaker configured to produce one or more audible noises or messages based on a communication received from the electric trap controller, and further comprising a safety enclosure completely surrounding the electrically conducting platform, wherein the safety enclosure comprises a door that is configured to be opened to create an opening in the safety enclosure, wherein the door is further configured to be closed sealing the opening in the safety enclosure, and wherein the electric trap controller controls operation of the door.

6. The electrical trapping system according to claim 1, wherein the electrically conducting platform and the one or more supports are configured to have the animal partially located on the electrically conducting platform and ground, and wherein the animal functions as a closed switch between the electrically conducting platform and the ground thereby shocking the animal once electricity is provided to the electrically conducting platform.

7. The electrical trapping system according to claim 1, further comprising a plurality of electrical trap units each comprising a respective electrically conducting platform, a respective power supply, and a respective electric trap controller, wherein the respective electric trap controllers of the plurality of electrical trap units are configured to communicate with at least one additional electrical trap unit of the plurality of electrical trap units.

8. The electrical trapping system according to claim 1, further comprising a plurality of electrical trap units each comprising a respective electrically conducting platform, a respective power supply, and a respective electric trap controller; and further comprising a computing device in communication with each of the plurality of electrical trap units, wherein the computing device is configured to cause each of the respective power supplies of the plurality of electrical trap units to discharge an electrical charge to each of the respective electrically conducting platforms of the plurality of electrical trap units to incapacitate one or more animals electrically coupled with at least one of the electrically conducting platforms.

9. An electrical trapping system, comprising:
a plurality of electrical trap units, wherein each of the plurality of electrical trap units respectively comprises:
an electrically conducting platform isolated from ground via one or more supports,
a power supply coupled to the electrically conducting platform, and
an electric trap controller coupled to the power supply, wherein the electric trap controller is configured to cause the power supply to discharge an electrical charge to the electrically conducting platform to incapacitate an animal electrically coupled with the electrically conducting platform;
wherein the respective electric trap controllers of the plurality of electrical trap units are configured to communicate with at least one additional electrical trap unit of the plurality of electrical trap units.

10. The electrical trapping system according to claim 9, wherein each of the plurality of electrical trap units further comprises an activation device configured to cause the respective electric trap controller to cause the respective power supply to discharge the electrical charge to the electrically conducting platform, and a respective bait container located on a surface of the electrically conductive platform, wherein the respective bait container is configured to store bait intended to attract one or more animals.

11. The electrical trapping system according to claim 9, wherein each of the plurality of electrical trap units further comprises a respective sensor coupled with the respective electric trap controller, wherein the respective sensor is configured to provide one or more signals to the respective electric trap controller regarding a status of at least one characteristic of the respective power supply, the respective electrically conducting platform, and the respective electric trap controller.

12. The electrical trapping system according to claim 9, wherein each of the plurality of electrical trap units further comprises a respective camera configured to capture one or more images or videos, wherein the respective camera is configured to provide the one or more images or videos to the respective electric trap controller, wherein the respective electric trap controller is configured to perform image processing on the images or videos, and wherein the respective electric trap controller is configured to take one or more actions based on the image processing.

13. The electrical trapping system according to claim 9, wherein each of the plurality of electrical trap units further comprises a respective speaker configured to produce one or more audible noises or messages based on a communication received from the respective electric trap controller, and further comprising a respective safety enclosure completely surrounding the respective electrically conducting platform, wherein the respective safety enclosure comprises a respective door that is configured to be opened to create a respective opening in the respective safety enclosure, wherein the respective door is further configured to be closed sealing the respective opening in the respective safety enclosure, and wherein the respective electric trap controller controls operation of the respective door.

14. The electrical trapping system according to claim 9, wherein the respective electrically conducting platform and the respective one or more supports are configured to have the animal partially located on the respective electrically conducting platform and ground, and wherein the animal functions as a respective closed switch between the respective electrically conducting platform and the ground thereby shocking the respective animal once electricity is provided to the respective electrically conducting platform.

15. An electrical trapping system, comprising:
a plurality of electrical trap units, wherein each of the plurality of electrical trap units respectively comprises:
an electrically conducting platform isolated from ground via one or more supports, and
a power supply coupled to the electrically conducting platform;
an electric trap controller coupled to the power supply, wherein the electric trap controller is configured to cause the power supply to discharge an electrical charge to the electrically conducting platform to incapacitate an animal electrically coupled with the electrically conducting platform; and
an electric trap controller in communication with each of the plurality of electrical trap units, wherein the electric trap controller is configured to cause each of the respective power supplies of the plurality of electrical trap units to discharge an electrical charge to each of the respective electrically conducting platforms of the plurality of electrical trap units to incapacitate one or more animals electrically coupled with at least one of the electrically conducting platforms.

16. The electrical trapping system according to claim 9, wherein each of the plurality of electrical trap units further comprises an activation device configured to cause the respective power supply to discharge the electrical charge to the electrically conducting platform, and a respective bait container located on a surface of the electrically conductive platform, wherein the respective bait container is configured to store bait intended to attract one or more animals.

17. The electrical trapping system according to claim 9, wherein each of the plurality of electrical trap units further comprises a respective sensor coupled with the electric trap controller, wherein the respective sensor is configured to provide one or more signals to the electric trap controller regarding a status of at least one characteristic of the respective power supply, and the respective electrically conducting platform.

18. The electrical trapping system according to claim 9, wherein each of the plurality of electrical trap units further comprises a respective camera configured to capture one or more images or videos, wherein the respective camera is configured to provide the one or more images or videos to the electric trap controller, wherein the electric trap controller is configured to perform image processing on the images or videos, and wherein the electric trap controller is configured to take one or more actions based on the image processing.

19. The electrical trapping system according to claim 9, wherein each of the plurality of electrical trap units further comprises a respective speaker configured to produce one or more audible noises or messages based on a communication received from the electric trap controller, and further comprising a respective safety enclosure completely surrounding the respective electrically conducting platform, wherein the respective safety enclosure comprises a respective door that is configured to be opened to create a respective opening in the respective safety enclosure, wherein the respective door is further configured to be closed sealing the respective opening in the respective safety enclosure, and wherein the electric trap controller controls operation of the respective door.

20. The electrical trapping system according to claim 9, wherein the respective electrically conducting platform and the respective one or more supports are configured to have the animal partially located on the respective electrically conducting platform and ground, and wherein the animal functions as a respective closed switch between the respective electrically conducting platform and the ground thereby shocking the respective animal once electricity is provided to the respective electrically conducting platform.
